(19) United States
(12) Patent Application Publication
(10) Pub. No.: US 2004/0197226 A1
(43) Pub. Date: Oct. 7, 2004

(54) Remote site urine collection device and method of use

(75) Inventors: Robert A. Ray, Stuart, FL (US); May S. Lui, Sebastian, FL (US); Susan Summers, Stuart, FL (US); Brian Smith, Port St. Lucie, FL (US)

Correspondence Address: AKERMAN SENTERFITT, P.O. BOX 3188, WEST PALM BEACH, FL, 33402-3188, US

(73) Assignee: FlexSite Diagnostics, Inc., Palm City, FL (US)

(21) Appl. No.: 10/826,230

(22) Filed: Apr. 16, 2004

Related U.S. Application Data
(62) Division of application No. 09/222,123, filed on Dec. 29, 1998.

(51) Int. Cl. G01N 21/00

(52) U.S. Cl. 422/56

(57) ABSTRACT

A device for collecting, drying, and transporting a urine sample, and extracting an analyte of interest from the dried sample for determining the presence or absence of the analyte or, if present, the amount or concentration thereof, is described. A preferred embodiment of the device is a sample collection strip which includes a collection pad for collecting and retaining the sample and a handle member for handling or manipulation of the device. Methods of use, and kits relating to the device are also described.

### BACKGROUND OF THE INVENTION

Analysis of biological fluids has long been used for diagnosing disease or metabolic disorders of living organisms. Blood and urine have been a primary source for obtaining biological components from animals, especially humans, for conducting such analyses. While blood components can be useful for determining a range of information about the health condition of an animal, obtaining a blood sample is still considered invasive. Thus, collection of urine, and analysis of certain components contained therein, can be advantageous for determining the health status of an animal, especially those which may be at risk of developing, or have developed, nephropathies or other renal, urinary, or metabolic disorders.

There are multiple renal disease etiologies in which laboratory findings include proteinuria. Albumin is the prominent protein in most renal diseases. Micro-albuminuria refers to albumin concentration in urine which is greater than normal, but usually not detectable with routine protein dipstick assays which permit measurement of albumin of 15 mg/dL or greater. Monitoring low concentrations of albumin in the urine is helpful for early detection of nephropathy in patients at risk for renal disease.

Those at risk for renal disease in which albuminuria may be present include, but are not limited to, patients with Type I and Type II diabetes, hypertension, and renal disease in pregnancy.

Of all patients beginning therapy for end-stage renal disease in the United States, diabetic nephropathy is the major cause of renal failure in twenty-five percent. Recent studies of the natural history of patients with long standing diabetes showed that microalbuminuria preceded clinical diabetic nephropathy. Further studies indicate that normalization of blood glucose and blood pressure can prolong the progression from microalbuminuria to clinical nephropathy.

Rapid tests have been developed for on-site urinalysis. For example, Boehringer Mannheim Corporation (Indianapolis, Ind., USA) manufactures Micral™ urine test strips, a semi-quantitative microalbuminuria test for early detection of subclinical nephropathy. However, this test involves binding of the urine albumin with a specific antibody-gold conjugate which is present on the strip. Albumin content is determined by a color change when a conjugate-albumin immunocomplex is formed. One disadvantage of this test, like other immunoassays, is that the determination must be made at the time of testing. According to the product literature or “label,” the color reaction must be determined within five minutes of color development because the immunocomplex (and color change) disintegrates thereafter.

Another product available from Boehringer Mannheim Corporation is Chemstrip® which is a rapid multi-parameter test strip which is used to measure certain constituents in urine, including specific gravity, pH, leukocytes, nitrite, protein, glucose, ketones, urobilinogen, bilirubin, blood, and hemoglobin, which are useful in the evaluation of renal, urinary, and metabolic disorders. This test also involves a color change directly on the strip which is compared to a standardized color chart for component measurement. However, this Chemstrip® product is also limited in its long-term stability after contact with urine. The color changes which are used in determining results are stable only about 120 seconds after immersion. The product labeling indicates that “color changes that occur after 2 minutes from immersion are not of clinical value.”

On-site rapid tests which use a color change for determining measurement of urine components can also be less precise and less accurate than conventional laboratory testing of those components. One reason is that the user, unfamiliar with standard laboratory or medical diagnostic procedures, may not fully appreciate the need for accurately following the prescribed testing procedure. Even minor deviation from the prescribed protocol can affect results and, hence, diagnosis.

Heretofore, remote-site sampling of urine, i.e., collection of a urine sample for transport to and analysis in a laboratory, was limited to collection of a liquid sample. The limitations and disadvantages of collection and transport of liquid samples are obvious and include the need to collect minimum volumes, as well as the risks of contamination, breakage, spillage, or degradation.

A need thus exists for a device and method for remote-site collection of a urine sample which provides for the sample to be transported in a dry state for subsequent urinalysis in a laboratory. Ideally, such a device and method would provide for collecting minimum volumes which can be standardized for precise and accurate analysis, as well as reducing the risk of contamination and eliminate the risk of spillage or degradation.

### BRIEF SUMMARY OF THE INVENTION

The subject invention concerns a device and method for collection, stabilization, preservation, transport, storage, processing, and compatibility with laboratory analysis of a biological sample obtained from a living organism. In particular, the subject invention concerns a device and method used in the collection and analysis of a component in a urine sample obtained from an animal. Methods and kits are also described for use of the subject device.

The subject invention provides for a device which is useful for collecting a urine sample from an animal, e.g., a human, drying of the urine sample on the device, transporting the collected and dried urine sample to a laboratory or other facility for analysis, and eluting or extracting an analyte of interest from the dried sample for determining the presence or absence of the analyte or, if present, the amount or concentration thereof.

One embodiment of the subject device is a collection strip which comprises a non-reactive collection pad for collecting and retaining a urine sample containing an analyte of interest, and a handle member on which the collection pad can be disposed whereby the handle member can facilitate handling or manipulation of the device without the user having to directly contact the collection pad. Preferably, the handle member is an elongate strip of material, e.g., high impact polystyrene, which is rigid enough to prevent drooping or bending of the handle member in normal use. The strip forms a handle end by which the user can hold the device, and a collection end which provides an area for disposing the collection pad.

In a preferred embodiment, the collection pad comprises an absorbent, sponge-like material which can readily absorb the liquid urine sample. The collection pad functions to retain the sample and its components in an unreacted state, even when the sample is dried. Advantageously, the collection pad allows for high-recovery extraction of the dried sample, or an analyte therein, for subsequent laboratory analysis. The collection pad can be a polymeric material, e.g., polyvinyl alcohol, or glass fiber, cellulose, or the like. In addition, the collection pad can be treated with a preservative for preventing premature breakdown or denaturation of the analyte of interest, or with a blocking agent which can prevent irreversible binding of an analyte of interest so that recovery of the analyte is maximized.

The collection pad can be a separate member affixed to the collection end of the strip or can be made integral with the strip. Preferably, the handle member and collection pad form a unitary device for collecting and processing of the sample. The device can be made to provide a means for separating or removing at least a portion of the collection pad from the strip.

One embodiment providing a removable portion of the collection pad includes a collection pad permanently affixed to one face of the strip wherein the collection end of the strip has an opening or aperture therethrough, over which the collection pad is affixed. This apertured configuration of the collection end of the strip provides at least partial exposure of the face of the collection pad contacting the strip. A portion of the collection pad can then be separated from the remainder of the pad by a hole punching apparatus or other cutting means which can remove a portion of predetermined size from the pad. The removal of a portion of the collection pad-having a predetermined size can be useful for collection and extraction of consistent amounts of sample.

In use, the subject device is provided as a unitary sample collection strip or “dipstick” comprising the handle member and collection pad. The urine sample can be applied to the collection pad, e.g., by holding the strip at the handle end and contacting the collection pad with a liquid urine sample to saturate the collection pad. The pad is then allowed to dry, is packaged for shipping, and is transported, typically by mail, to a laboratory for analysis. The analysis is performed by removing a predetermined sized portion of the collection pad, performing an extraction method to recover an analyte of interest from the collection pad, and determining presence or absence of the analyte or, if present, measuring an amount or concentration of the analyte. The results of the analysis can then be reported to a physician and/or the patient.

The manufacture of the subject device comprises providing an elongate strip of a relatively rigid material, e.g., a plastic or polymeric material, which has a handle end serving as a handle for holding and manipulating the device and a collection end which provides a substrate for a urine collection pad. An opening can be formed through the strip at the collection end by punching or cutting the strip.

The collection pad comprises a relatively flat section of absorbent, sponge-like material, and can be shaped as desired. Typically, the collection pad is a square, substantially equal or slightly smaller in width than the width of the strip. After forming the opening in the collection end of the strip, the collection pad can be affixed or adhered to one face of the strip, in a position and being of relative size to completely cover the opening.

Preferably, the collection pad can be affixed to the strip by applying appropriate amounts of heat and pressure so that adhesion forms between the pad and strip materials. Alternatively, the collection pad can be ultrasonically welded to the strip, adhered by applying a compatible adhesive between the pad and strip, or affixed by a mechanical fastening means.

Multiple strips can be manufactured by providing a sheet of strip material which is cut to length of the strips. Openings can be formed at one end of the sheet at appropriate positions for forming multiple strips. A strip of collection pad material can then be applied over the openings, and the sheet can be cut into individual strips.

### BRIEF DESCRIPTION OF THE DRAWINGS

FIG. 1 Shows an exploded perspective view of one embodiment of the device according to the subject invention.

FIG. 2 shows a configuration for making multiple strips from a single sheet of strip material.

FIG. 3 shows an embodiment of the device according to the subject invention comprising a plurality of collection pads disposed on the strip.

FIGS. 4A-4D show results of testing a device according to the subject invention for percent recovery of analyte in samples spiked with known concentrations of albumin. FIG. 4A shows recovery of known standards from a neat sample (i.e., not applied to the device); FIG. 4B shows recovery from an undried collection pad; FIG. 4C shows recovery from a collection pad dried overnight at room temperature; and FIG. 4D shows recovery from a collection pad dried overnight at room temperature and at 45 degrees C. for two days.

FIGS. 5A-5C show results of a correlation study using a device according to the subject invention over a range of albumin concentrations (measured as a ratio of microalbumin to creatinine) at increasing drying times versus neat samples (unapplied to the device). FIG. 5A shows microalbumin/creatinine ratios for 1 day drying at room temperature; FIG. 5B shows microalbumin/creatinine ratios for 4 day drying at room temperature; and FIG. 5C shows microalbumin/creatinine ratios for 7 day drying at room temperature.

FIG. 6 shows stability testing of a device according to the subject invention measured as microalbumin/creatinine ratios at room temperature at 0, 1, 4, and 7 days drying time.

FIG. 7 shows results from a comparative study between two polymeric hydrogel materials, namely, Merocel® and Clinicel®, at different drying times and temperatures.

### DETAILED DESCRIPTION OF THE PREFERRED EMBODIMENTS

The subject invention concerns a device and method for collection, stabilization, preservation, transport, storage, processing, and compatibility with laboratory analysis of a biological sample obtained from a living organism. In particular, the subject invention concerns a device and method used in the collection and analysis of a component in a urine sample obtained from an animal.

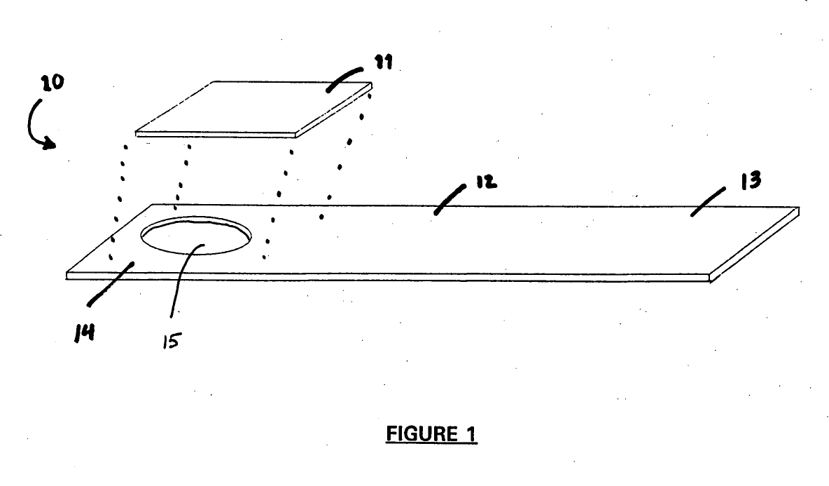

The subject device can be understood by reference to the accompanying drawings. FIG. 1 shows an embodiment of the subject device which is useful for collecting a urine sample from an animal, e.g., a human, drying of the urine sample on the device, transporting the dried collected urine sample to a laboratory or other facility for analysis, and eluting or extracting an analyte of interest from the sample for determining the presence or absence of the analyte or, if present, the amount or concentration thereof.

Specifically, FIG. 1 shows a device 10 according to the subject invention comprising non-reactive collection pad 11 for collecting and retaining a urine sample containing an analyte of interest, and a handle member or strip 12 to facilitate handling of the device without contacting the collection pad. Preferably, the handle member 12 is an elongate strip of material, e.g., high impact polystyrene, which is rigid enough to prevent drooping or bending of the handle member in normal use.

Typically, the strip forming the handle member is a polystyrene material about 2 mm in thickness. This thickness retains rigidity of the strip and allows for a hole punching apparatus to be used to remove a portion of the collection member. It would be understood that other materials can be used for the strip so long as the material performs the stated functions of the device and is compatible with the collection pad material and with urine.

The strip of material forms a handle end 13 by which the user can hold the device, and a collection end 14 which provides an area for disposing of the collection pad. In a preferred embodiment, the collection pad comprises an absorbent, sponge-like material which can readily absorb the liquid urine sample. The collection pad functions to retain the sample and its components in an unreacted state, even when the sample is dried. Advantageously, the collection pad allows for high-recovery extraction of the dried sample, or an analyte therein, for subsequent laboratory analysis.

The collection pad can be a polymeric material, preferably a hydrogel material, e.g., polyvinyl alcohol, or glass fiber, cellulose, or the like, or can be a mixture of materials. Polyvinyl alcohol (PVA) materials which can be used for the collection pad are Merocel®, available from Merocel Scientific Product, Inc. (Mystic, Conn., USA) or Clinical®, available from M-Pact (Endora, Kans., USA). Merocel® and Clinicel® are available in varying pore sizes and densities. For example, the densities of Merocel® range from about 0.049 to about 0.1 g/cc, dry. The pore sizes range from about 0.01 to about 1.2 mm.

A preferred Merocel® product for use in the subject invention is marketed as “CF-100” which has the following properties: density (dry, g/cc)—0.067; average pore size—0.45 mm; pore size range—0.02-0.6 mm; void volume 93%; absorbency time—<5 seconds; absorptive capacity (g water/g sponge)—16×; retained capacity (g water/g sponge)—12×; tensile strength—46 psi; and percent elongation—210.

The collection pad is preferably substantially non-reactive in that there is no reagent, indicator, or other component included in the pad which provides for rapid, on-site determination or measurement of analyte. For example, the subject invention does not include a pad which changes color according to exposure to varying amounts of analyte so that the patient can immediately determine results. However, the collection pad can be treated with a preservative for preventing premature degradation or denaturation of the analyte of interest, or can be treated with a blocking agent which can prevent irreversible binding of an analyte of interest to facilitate recovery thereof. A preferred blocking agent for use in determining microalbumin concentrations is bovine serum albumin (BSA). The preferred pretreatment comprises saturating the collection pad in a 500-1000 mg/L solution of BSA in 0.1M Tris (pH 7.6), then allowing the pad to dry.

The collection pad is shown as a separate member affixed to the collection end on a top face of the strip. Regardless of the way in which the collection pad is affixed to the strip, it is preferable that the handle member and collection pad form a unitary device for collecting and processing of the sample. As further illustrated in FIG. 1, a means for providing a removable portion of the collection pad 11 can include providing an opening or aperture 15 through the collection end 14 of the strip. The collection pad is affixed onto the strip 12, over the aperture. 1 5 at the collection end 14. This aperture 1 5 formed in the collection end 14 of strip 12 provides at least partial exposure of the face of the collection pad contacting the strip.

A portion of the collection pad can then be separated from the remainder of the pad by a hole punching apparatus or other cutting means which can remove a predetermined sized portion of from the pad. It would be understood that the collection pad can alternatively be pre-scored with a die-cut or perforation to facilitate separation and removal of the predetermined sized portion, or that a predetermined sized collection pad can be removably affixed to or made removably integral with the handle component. The predetermined size of the removable portion of the collection pad provides for collection and extraction of consistent amounts of sample or analyte.

In use, the subject device is provided as a unitary sample collection strip or “dipstick” comprising the handle member and collection pad. The urine sample can be applied to the collection pad by direct exposure during urination or, preferably, can be applied by holding the strip at the handle end and dipping the collection end comprising the collection pad into a liquid urine sample which has been collected or placed in a container. The collection pad is allowed to become saturated with sample. Such “dipstick” procedures are well-known in the art.

Once the urine sample is saturated onto the collection pad, the pad is allowed to dry for at least one to two hours, and preferably overnight. The device can then be packaged for shipping and transported, typically by mail, to a laboratory for analysis.

The urinalysis is performed by removing the predetermined sized portion of the collection pad and performing an extraction method to recover an analyte of interest from the collection pad. Typically, the removed portion of the collection pad is placed into a container and eluted with water or aqueous buffer solution to extract the analyte from the collected sample. The presence or absence of the analyte can then be determined or, if present, the amount or concentration measured, by standard procedures which are well known in the art. The determination or measurement is preferably made by a commercially available automated analyzer. The results of the analysis can then be reported to a physician and/or the patient.

Advantageously, the subject device provide for near 100% recovery of analyte when tested using a control solution to which a known concentration of analyte has been added or “spiked.” Recoveries are consistently greater than 60% and, on average, are approximately 80% or greater when tested on the day following overnight drying. Recovery of analyte from a clinical sample is considered to be comparable. The subject device can be used for determination or measurement of all analytes commonly assayed in urinalysis panels performed by clinical laboratories. Primarily, however, the subject invention is useful for determining presence or absence or measuring low concentrations of urinary albumin (microalbumin). In addition, the subject device can be advantageous for determining presence or absence or measuring metabolites indicative of osteoporosis, e.g., pyrilinks-D or N-telopeptides.

The manufacture of the subject device comprises providing an elongate strip of a relatively rigid material, e.g., a plastic or polymeric material, which has a handle end serving as a handle for holding and manipulating the device, and a collection end which provides a support layer for a urine collection pad. The dimensions of the strip are not critical so long as they allow for performing all necessary functions as described herein. For example, the length of the strip should be of sufficient length to facilitate handling of the device without requiring the user to directly contact the collection pad. Any contact of the collection pad in the collection process can contaminate the sample and can be contrary to good hygiene practices once the collection pad is saturated with urine. Typically, the strip is about four inches in length and about 3/4 inches in width which allows the user to easily dip the device into a urine sample collected into a standard collection cup.

The thickness of the strip should provide a relatively rigid device so that the strip does not droop or bend in use. In addition, it can be advantageous for drying if the strip can be rigid enough to be laid across the top of the urine sample collection cup during the drying process. On the other hand, the thickness of the strip should not be such that it does not fit between the working ends of a standard hole punching apparatus or is too thick to be easily punched by a punch press. Typically, a polystyrene material of about 2 mm in thickness is sufficient to meet these requirements.

An opening 15 through the strip at the collection end can be formed by cutting the strip, preferably centrally punching out a generally circular or ovoid section from the collection end so that the face of the collection pad contacting the strip is exposed when disposed onto the strip. The opening should preferably be larger than the predetermined sized portion of the collection pad which is removable from the device. A preferred size for the opening is therefore greater than 1/4 inch and is typically about 7/16 inches in diameter. Exposure of the contact face of the collection pad can be advantageous for thorough drying of the collection pad and for accessing the collection pad with a hole punching apparatus for removing a predetermined sized portion of the pad. The predetermined size of the removable portion of the collection pad is preferably approximately 3/16-1/4 inch in diameter so that a minimum amount of sample required for testing can be absorbed into and recovered from the collection pad.

The collection pad comprises a relatively flat section of absorbent, sponge-like material, and can be shaped as desired. Typically, the collection pad is a square, substantially equal or slightly smaller in width than the width of the strip, and is of standard thickness as is commercially available for the material. After forming the opening in the collection end of the strip, the collection pad can be affixed or adhered to one face of the strip, in a position and being of relative size to completely cover the opening. Preferably, the collection pad can be affixed to the strip by applying appropriate amounts of heat and pressure so that adhesion forms between the pad and strip materials. Alternatively, the collection pad can be ultrasonically welded to the strip, adhered by applying a compatible adhesive between the pad and strip, or affixed by a mechanical fastening means.

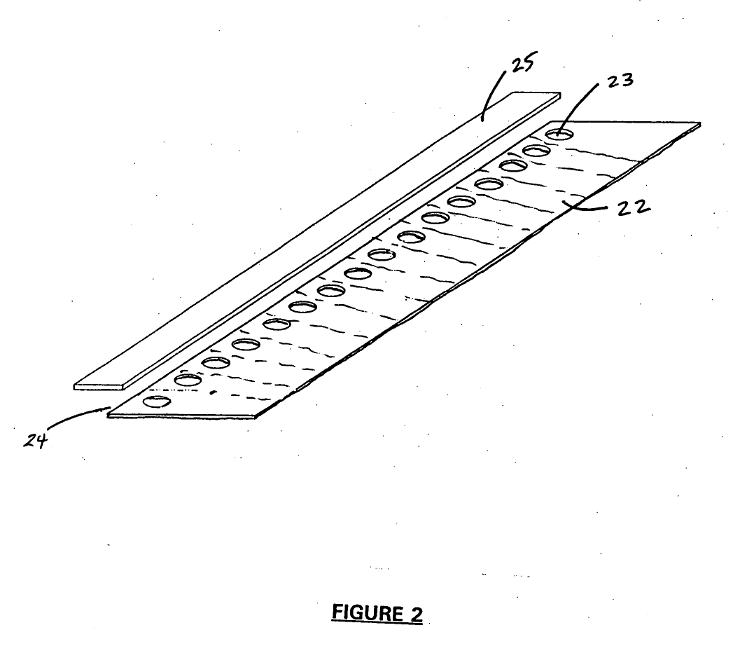

As shown in FIG. 2, multiple strips can be manufactured by providing a sheet 22 of strip material which is cut to length of the strips, preferably about four inches. Openings 23 can be formed at one end, referred to herein as the collection end 24, of the sheet at appropriate positions for forming multiple strips. A strip of collection pad material 25 can then be applied over the openings, and the sheet can be cut into individual strips, shown by the dotted lines.

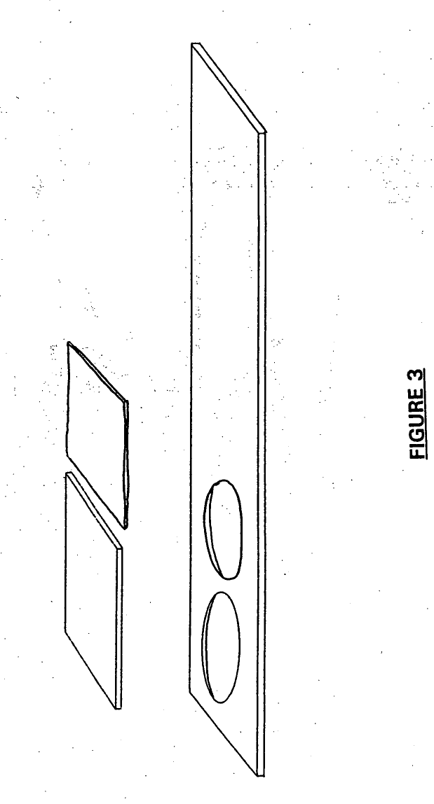

It would also be understood by persons of ordinary skill in the art, in view of the disclosure herein, that other embodiments are contemplated for the subject device. One of these alternative embodiments is shown in FIG. 3, which provides a device according to the subject invention having a plurality of collection pads disposed thereon for collecting separate or multiple samples from a single urine specimen.

The embodiment shown in FIG. 3 comprises two separate collection pads and two apertures formed in the collection end of the strip. In addition, the collection pads and apertures are shown aligned along a longitudinal axis of the strip. It would be understood that more than two collection pads can be provided on a single strip and that the plurality of collection pads can alternatively be aligned side-by-side on the collection end of the strip.

The subject invention further concerns a kit for enabling an individual to collect a sample and transport the collected sample to a facility for analysis in general, the kit, comprising at least one of the above-described devices and instructions for use of the device, can further include separately packaged components selected from the following: sterile urine collection cup, transport packaging, or an information card for providing information, e.g., medical history or health status of the individual being tested for disease or metabolic disorder.

Following are examples which illustrate procedures for practicing the invention. These examples should not be construed as limiting.

### EXAMPLE 1

### Recovery of Urinary Albumin

To determine recovery of albumin added to normal urine, a device according to a preferred embodiment of the subject invention, namely a ¾″×4″×2 mm strip having a ¾″×¾″ Merocel® collection pad disposed thereon, was saturated by dipping the device into a urine sample spiked with either 10, 50, 1 00 or 200 mg/dL albumin.

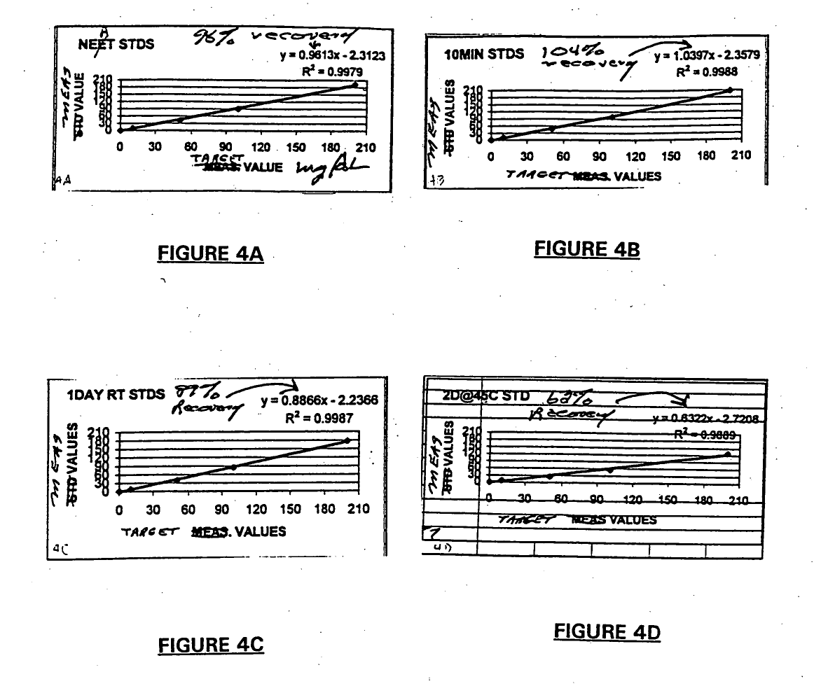

Testing was done on a neat sample of urine (i.e., collected sample which was not applied to the subject device), on samples applied to and extracted from the collection pad of the subject device, ten minutes following application of urine to the collection pad, on samples extracted following drying, overnight at room temperature on the collection pad, as well as samples collected following drying overnight at room temperature then at 45 degrees C. for two days to simulate mailing conditions. The results are shown in FIGS. 4A-4D and indicate greater than 60% recovery for all conditions and from 96-104% recovery after 10 minutes drying time on the collection pad. The greater than 100% recovery was likely due to a concentration phenomenon.

### EXAMPLE 2

### Correlation of Collected Urinary Albumin to Neat Sample

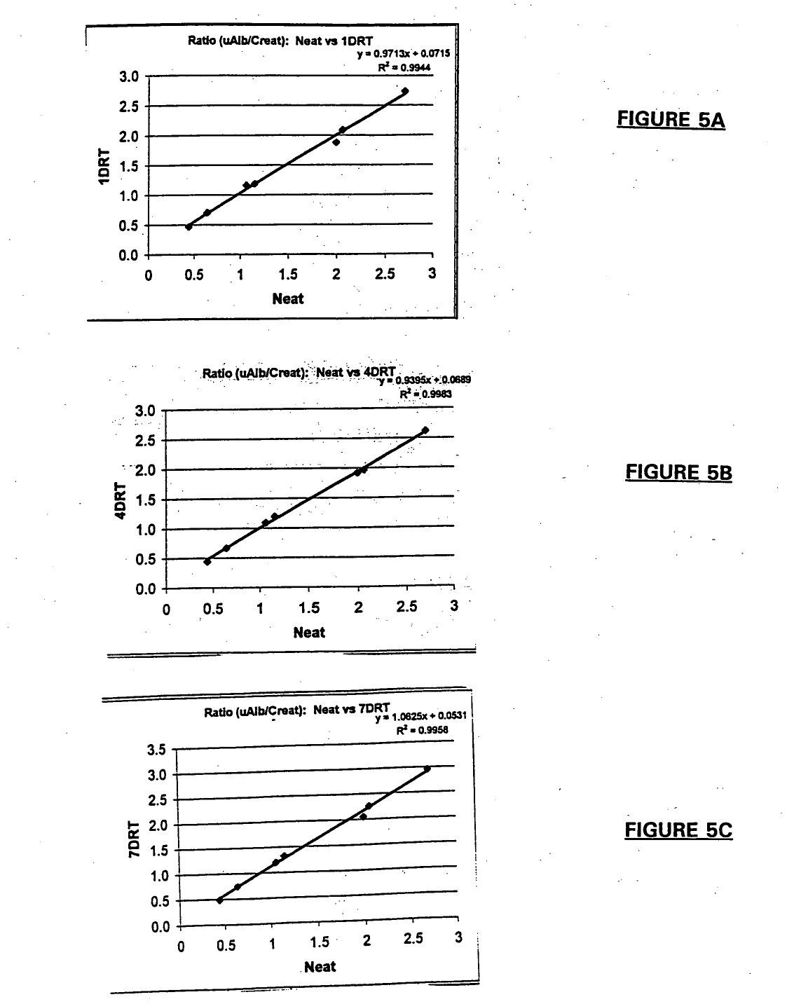

Correlation and stability of albumin collected onto an embodiment of the subject device as described in Example 1 was tested over a range of albumin concentrations (measured as a ratio from 0 to 3 of microalbumin to creatinine) at increasing drying times versus neat samples (samples unapplied to the device). The results of these tests are shown in FIGS. 5A-5C. Each of the tests demonstrates excellent correlation with a neat sample for up to 7 days of drying time. Microalbumin/creatinine ratios for 1, 4, and 7 days drying at room temperature show greater than 99% correlation (R²=0.99 or greater) as shown in FIGS. 5A-5C.

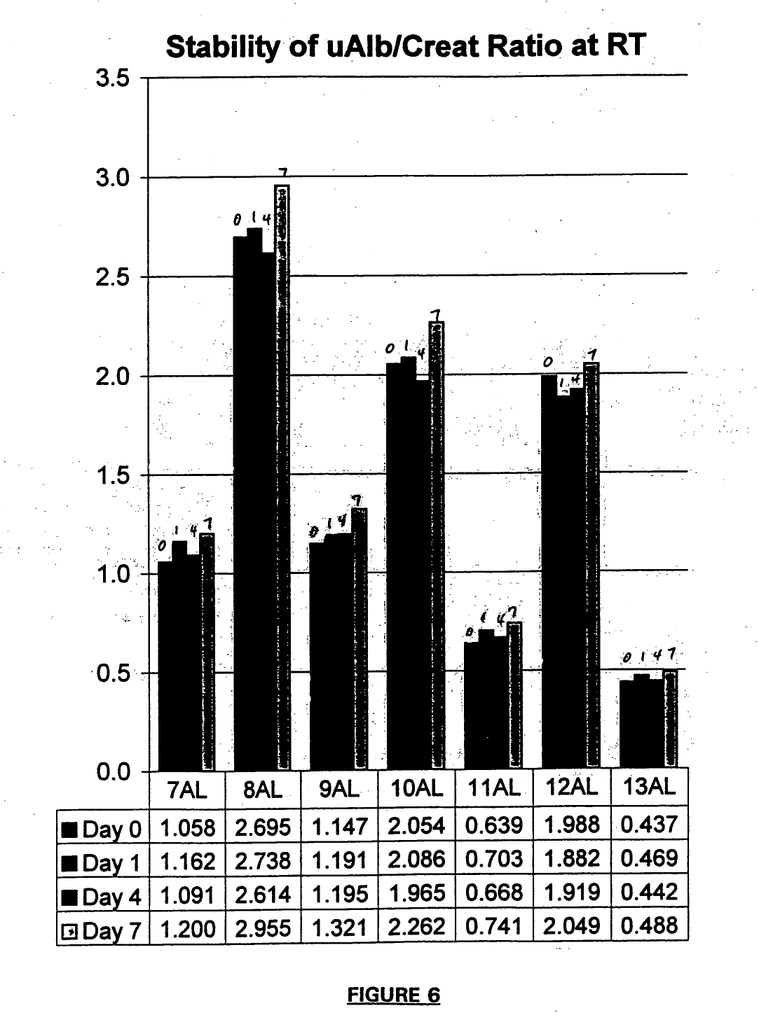

Stability testing of the device described in Example 1 was measured as microalbumin/creatinine ratios at room temperature at 0, 1, 4, and 7 days drying time for multiple samples. Samples collected on the subject device showed excellent stability for up to 7 days drying time (FIG. 6).

### EXAMPLE 3

### Comparison of Polyvinyl Alcohol Materials

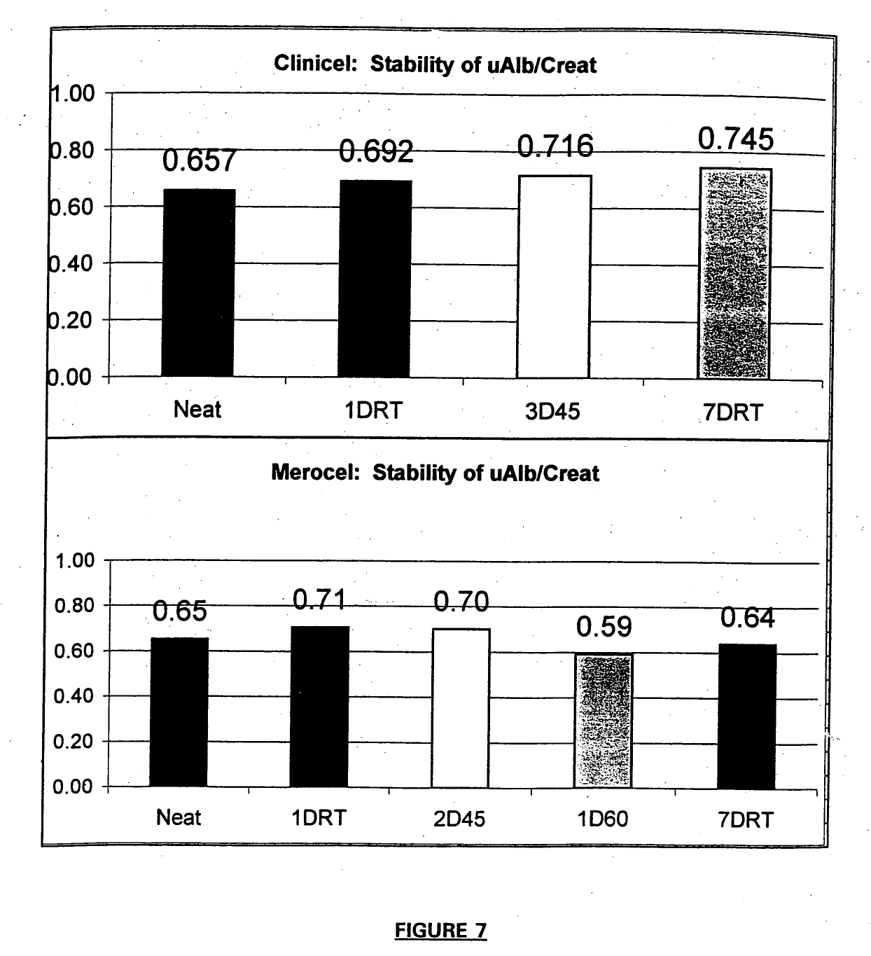

A comparative study between two polymeric hydrogel materials, namely, Merocel® and Clinicel®, at different drying times and temperatures was conducted to determine potential differences in materials used for the collection pad of the subject device. Neat samples applied to each of the materials were tested along with samples collected after 1 day drying time at room temperature, after 3 days drying time at 45° C., and after 7 days drying time at room temperature. As shown in FIG. 7, stability of microalbumin/creatinine ratios over time was comparable for each of the materials. Microalbumin/creatinine ratios for Merocel® ranged from 0.692 to 0.745, compared to a ratio of 0.657 for the neat sample. Microalbumin/creatinine ratios for Clinicel® ranged from 0.64 to 0.71 compared to a ratio of 0.65 for the neat sample.

It should be understood that the examples and embodiments described herein are for illustrative purposes only and that various modifications or changes in light thereof will be suggested to persons skilled in the art and are to be included within the spirit and purview of this application and the scope of the appended claims.

What is claimed is:

1. A device for remote-site collection and drying of a liquid biological sample obtained from an individual for the purpose of mailing the dried sample for recovery and laboratory analysis of an analyte contained in the biological sample, said device comprising:
a relatively rigid strip forming a handle member having a handle end and a collection end, said collection end having a collection pad for collecting and drying the sample containing the analyte, said collection pad capable of having at least a portion thereof removed from the device to recover the analyte for detection or measurement by laboratory analysis.

2. The device of claim 1 wherein the biological sample is urine.

3. The device of claim 1 wherein the analyte is albumin.

4. The device of claim 1 wherein the collection pad is an absorbent material.

5. The device of claim 4 wherein the collection pad material is selected from hydrogel, glass fiber, glass fiber/cellulose mixtures, or cellulose.

6. The device of claim 5 wherein the hydrogel is polyvinyl alcohol.

7. The device of claim 1 wherein the strip has an aperture formed in the collection end which exposes a portion of a face of the collection pad contacting the strip.

8. The device of claim 1 wherein the collection pad is pre-treated with a reagent which facilitates the collection, separation, storage, transport, preservation, recovery, or analysis of the sample.

9. The device of claim 8 wherein the collection pad pre-treatment reagent is a solution comprising bovine serum albumin.

10. The device of claim 1 wherein the collection pad is substantially non-reactive for purposes of providing a rapid, on-site diagnostic test.

11. The device of claim 1 wherein said device comprises a plurality of collection pads.

12. The device of claim 1 wherein said device comprises a plurality of apertures formed in the collection end of the strip.

13. A method for remote-site collection of a biological sample and laboratory analysis of an analyte in the sample, said method comprising:
providing a collection device to an individual or a health care professional, said device comprising a relatively rigid strip forming a handle member having a handle end and a collection end, said collection end having a collection pad for collecting and drying the sample containing the analyte, said collection pad capable of having at least a portion thereof removed from the device to recover the analyte for detection or measurement by laboratory analysis;
applying the biological sample in liquid form to the device so that the analyte-containing component of interest is collected onto the collection pad;
drying said collection pad having the analyte-containing component of interest retained therein;
transporting the device to a facility for analysis of the analyte;
removing at least a portion of the collection pad from the device;
eluting the analyte from the collection pad;
determining presence, absence, or concentration of the analyte; and
reporting results of the analysis to the individual or health care professional.

14. The method of claim 13 wherein the drying step is completed before the step of removing at least a portion of the collection pad.

15. The method of claim 13 further comprising identifying the individual and sample by a code.

16. The method of claim 13 wherein the elution step is modified according to the particular analyte being determined or measured.

17. The method of claim 13 wherein the step of determining presence, absence, or measuring of the analyte is modified according to said analyte.

18. The method of claim 13 wherein the collection pad is substantially non-reactive for purposes of providing a rapid, on-site diagnostic test.

19. A kit for remote-site collecting of a biological sample from a patient for laboratory analysis of said sample, said kit comprising:
a sample collection device comprising a relatively rigid strip forming a handle member having a handle end and a collection end, said collection end having a collection pad for collecting and drying the sample containing the analyte, said collection pad capable of having at least a portion thereof removed from the device to recover the analyte for detection or measurement by laboratory analysis; and
an information card for providing information about the patient.

20. The kit of claim 19 wherein said kit further comprises a component selected from a urine collection cup, and packaging means for transporting the collected sample.
